(19) United States
(12) Patent Application Publication
(10) Pub. No.: US 2004/0105440 A1
(43) Pub. Date: Jun. 3, 2004

(54) Packet-switched network and network switches having a network layer forwarding action performed by data link switching

(75) Inventors: Graham Strachan, Aylesbury (GB); Paul J. Moran, Hemel Hempstead (GB); David Capon, Hemel Hempstead (GB); John P. Stubley, St Albans (GB)

Correspondence Address: NIXON & VANDERHYE, PC, 1100 N GLEBE ROAD, 8TH FLOOR, ARLINGTON, VA, 22201-4714, US

(73) Assignee: 3Com Corporation, Marlborough, MA

(21) Appl. No.: 10/721,866

(22) Filed: Nov. 26, 2003

(30) Foreign Application Priority Data
Nov. 27, 2002 (GB) 0227614.5

(51) Int. Cl. H04L 12/28

(52) U.S. Cl. 370/389; 370/401

(57) ABSTRACT

An edge switch for an Ethernet network maintains look-up tables of media access control addresses and network addresses for local sources and destinations at least two sub-nets, so that it can forward packets directly even when the local source and destination are on different sub-nets and forwards packets to a core router when the destination is not local to the edge switch.

### FIELD OF THE INVENTION

This invention relates to packet-switched communication networks, particularly Ethernet-type networks. The invention more particularly relates to achieving efficiency of operation in a complex network, such as one having a multiplicity of subnets or virtual local area networks, and more particularly to the reduction of unnecessary traffic between a core router and an edge switch wherein an edge switch is required to switch packets both between different entities on the same subnet but also between entities on different subnets.

### BACKGROUND TO THE INVENTION

Broadly speaking, apart from the media employed for the conveyance of data between devices, data networks are composed of data terminal equipment (DTE) which constitute the sources and ultimate destinations of data on the network, and switching devices which perform, as explained further below, both bridging and routing, and which fall into generally two categories, namely edge devices and core devices. Herein, ‘edge device’ is intended to mean a switching device which is the first encountered by packets on dispatch from data terminal equipment and/or the last encountered by a packet before it reaches its ultimate data terminal equipment. Herein ‘core device’ is intended to refer to a switching device which is separated from data terminal equipment by an edge device.

Packet switching between members of the same subnet or virtual local area network (VLAN) is commonly performed at the data link or media access control (MAC) level, often called ‘layer 2’ switching or bridging because the relevant (data link) layer in the open system's interconnection (OSI) model is the ‘second’ layer. Switching at this layer is normally between members of the same subnet, and only the layer 2 (MAC) address information in a packet is required.

Data packets of the kind employed in the present invention will normally have a format that includes a MAC address header, comprising a MAC source address (identifying the device from which the packet has come) and a MAC destination address (indicating the device to which the packet should be forwarded). They will also include an IP (internet protocol) header which typically includes an IP or network source address and a network destination address. As these names imply, MAC addresses are used to determine the device to which a packet should be sent whereas a network address identifies the network to which the packet should be sent.

As indicated above, layer 2 switching, normally performed between members of the same subnet, does not normally require any change in the header data of a packet. When a switching device receives a packet, it will perform a look-up in a ‘layer 2’ database which will contain an entry including the relevant destination address, and (for example) the port forwarding data, typically the number of the port from which the packet should be forwarded to reach that destination of the same subnet. It may also have a field which identifies that subnet. However, routing between different subnets is a more complex activity and usually requires recourse to a routing table which as well as the network destination address will include an identification of the relevant subnet and a MAC address which will have to be applied to the packet to take it on the next hop towards its destination. Routers commonly also perform various other functions which are not directly relevant to the present invention.

### SUMMARY OF THE INVENTION

In a layer 3 IP network, that is to say a network having a multiplicity of subnets and requiring IP switching, all traffic between subnets will normally travel from the edge of the network into a core where it will be routed and sent out again to the edge of the network. In some cases the source and destination stations might be connected to the same layer 2 edge device.

The basis of the present invention is the avoidance of an unnecessary return journey of a packet between a layer 2 edge device and the layer 3 core, thereby conserving both up-link and core bandwidth. The edge device can be provided with sufficient addresses to be able to forward the packet by means of a layer 3 look-up if both the source and destination end stations are on different sub-nets but are local to it but to switch (bridge) the packet at layer 2 up to the layer 3 core if they are not.

Further objects and features of the present invention will be apparent from the following detailed description with reference to the drawings.

### BRIEF DESCRIPTION OF THE DRAWINGS

FIG. 1 is a simplified schematic diagram of a switch.

FIG. 2 is a schematic diagram of a router.

FIG. 3 is a diagram illustrating a data packet.

FIG. 4 illustrates a fragment of a network.

FIG. 5 illustrates a known form of edge switching.

FIG. 6 illustrates one switching process according to the invention.

FIG. 7 illustrates the fragmentary network of FIG. 4 operated according to the present invention.

FIG. 8 illustrates a routing table.

### DESCRIPTION OF THE PREFERRED EMBODIMENTS

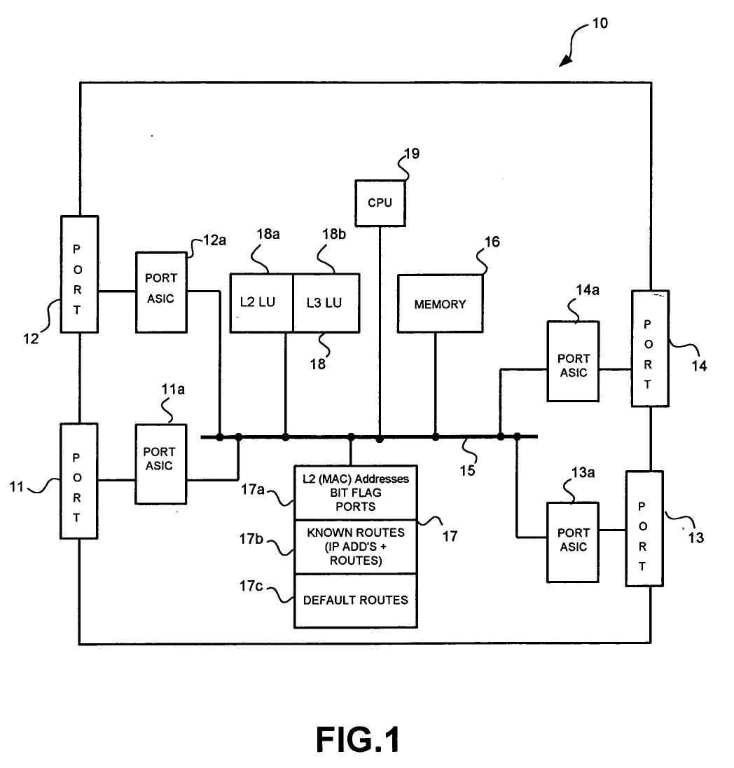

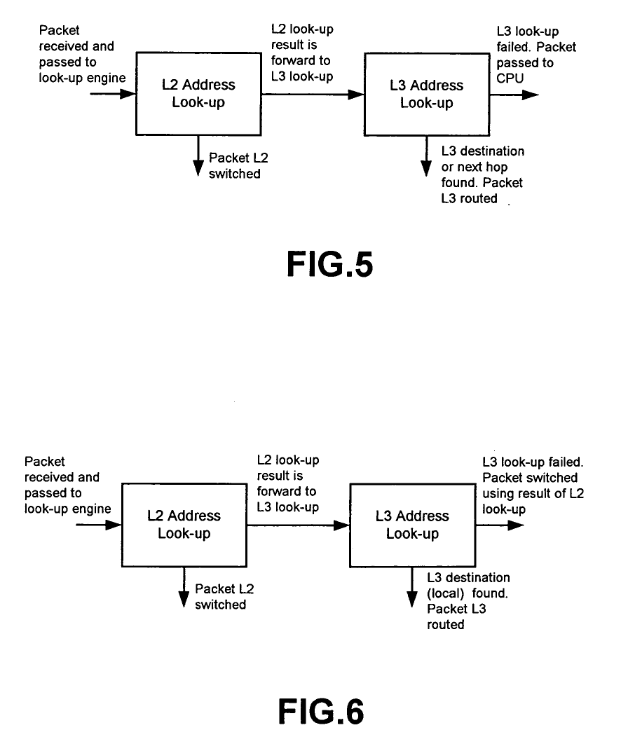

FIG. 1 of the drawings is a simplified schematic representation of an edge device (a switch) which can be used in the present invention. For the most part, the device 10 shown in FIG. 1 is of known form; however, as will be seen, it is necessary according to the invention that the device 10 should be capable of switching at layer 2 (employing media access control address data) as well as switching at layer 3 (utilising network address data). Also, the look-ups are interlinked, either in hardware or software as will be described later. Although switches which can switch according to both layer 2 and layer 3 information are known, in essence switches of that nature will examine the MAC destination address to determine whether the packet should be switched at layer 2 or layer 3 depending on whether the MAC destination address is identified with layer 3 switching. The difference between the switch in FIG. 1 and known switches will become more apparent after a discussion of FIGS. 5 to 7.

In order to provide a general view of the organisation of the switch, there follows a brief description of FIG. 1. The switch 10 in FIG. 1 will have a multiplicity of ports, herein represented as merely four ports (instead of a typical number such as twelve or twenty-four). Each of the ports is connected to a port ASIC, which will perform initial and final processing on packets and typically contains the physical sub-layer and data link sub-layer (or MAC). A system of buses is represented in FIG. 1 merely by a bus 15. Typically, packets received by any of the ports 11 to 14 will be stored in memory 16 while the headers of the packets are processed in order, for example, to perform look-ups with the aid of look-up databases 17 which can be accessed by a look-up engine 18. For convenience this engine 18 is shown as comprising a layer 2 look-up engine 18a (L2 LU) and a layer 3 look-up engine 18b (L3 LU). The engine 18a will have recourse to a layer 2 look-up table 17a, containing entries accessed by media access control addresses and yielding forwarding information such as port numbers, whereas the engine 18b will have recourse to layer 3 (routing) tables 17b and 17c, containing entries of network addesses and corresponding forwarding information, i.e known routes and possible default routes. As will become apparent some embodiments will need to preserve a look-up result from the layer 2 look-up even though a layer 3 look-up is performed.

The device includes a processor represented by a CPU 19.

The database or databases 17 (whether the address and forwarding data in the database is in one table or split into a number of tables 17a to 17b is not important) contains various types of information which will be more particularly described below.

A switch of the kind shown in FIG. 1 may be represented in practice by a switch type 4400 made by 3Com Corporation. Such a switch is ‘stackable’ in that it can be put into a cascade connection with other (similar) switches to form a single switch entity. One purpose of this is to provide a switch with a larger number of ports that a single switch in a simple manner not requiring reorganisation of the network generally.

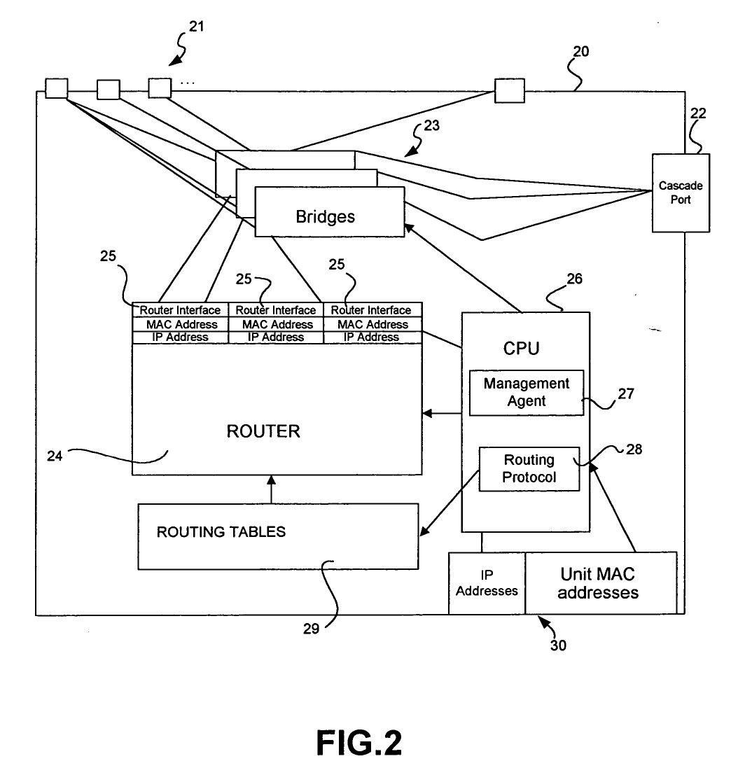

FIG. 2 illustrates a typical router of the kind which is intended for use as a core router in the present invention. This may also be a stackable device as described for example in GB-2386524-A.

The router unit 20 in FIG. 2 has a multiplicity of ordinary or ‘front panel’ ports 21 and a ‘cascade’ port 22. The unit includes at least one and usually a multiplicity of (hardware) bridges or layer 2 switches 23. Each port 21 is connected to at least one of the bridges 23 and the or each cascade port 22 is connected to all the bridges or to a ‘logical’ internal port connected to all the bridges 23. The unit includes a router 24 which has at least two, and in the illustrated example three, router interfaces 25. Each router interface 25 is connected to one bridge only, although each bridge may be connected to more than one router interface 25. For each interface there is some means such as a register storing a MAC address and a network (IP) address for the interface. For controlling the bridges and the router there is a processor constituted by a CPU 26 which has recourse, by means of an appropriate memory system, to a management agent 27 and a routing protocol 28. The routing protocol controls routing tables 29. Also embedded in the unit, in for example an interface 30 for the management agent, are the unit's normal addresses, i.e. its MAC address and its network (IP) address. These addresses are used for the management of the router, for example by an external network supervisor, and would according to prior practice be supplied by the CPU to the router interfaces.

Although ‘stacking’ is not directly relevant to the present invention, a router of the kind shown in FIG. 2 can be stacked and organised so that the stack has a lead router and subordinate routers in the manner described in GB patent application 0202425.5

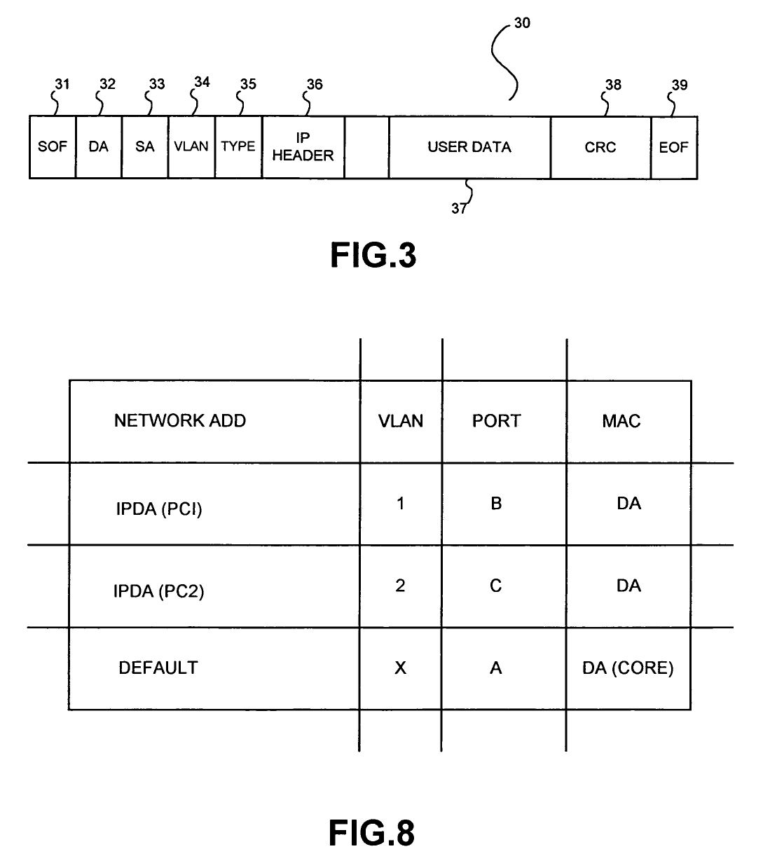

FIG. 3 illustrates schematically for the sake of completeness one example of a packet 30 which is employed in an Ethernet network. The various segments include a ‘start of frame’ SOF 31, a MAC address (layer-2) segment comprising a destination MAC address 32 and a source MAC address 33, a VLAN tag (comprising a tag header and a field identifying the VLAN (i.e. subnet), a ‘type’ field 35 (having the value 0×0800 for IP packets), network or internet protocol (layer-3) segment 36 comprising a network destination address (IPDA) and a network source address (IPSA), user data (i.e. payload) 37, a cyclic redundancy code (CRC) segment 38 and an end of frame (EOF) 39.

### DESCRIPTION OF PACKET SWITCHING ACCORDING TO THE INVENTION

In a normal ‘layer 3’ router, all packets forwarded to the router are routed either to a specific destination if the IP address is known or to one of a multiplicity of default routers if the IP (network) destination address is unknown.

The invention has broadly two aspects. One is the provision of a new manner of organising the routing of packets at the edge of a network. A further aspect of the invention is the organisation of a switch for this purpose.

In particular, it is intended that a packet should be ‘routed’ locally in an edge switch if possible and the packet should be switched at the data link layer (layer 2) to a core router if it be not possible to route the packet locally. In effect the core router will be a default router but packets will be switched to it by means of layer 2 (media access control) switching rather than at the logical (layer 3) level.

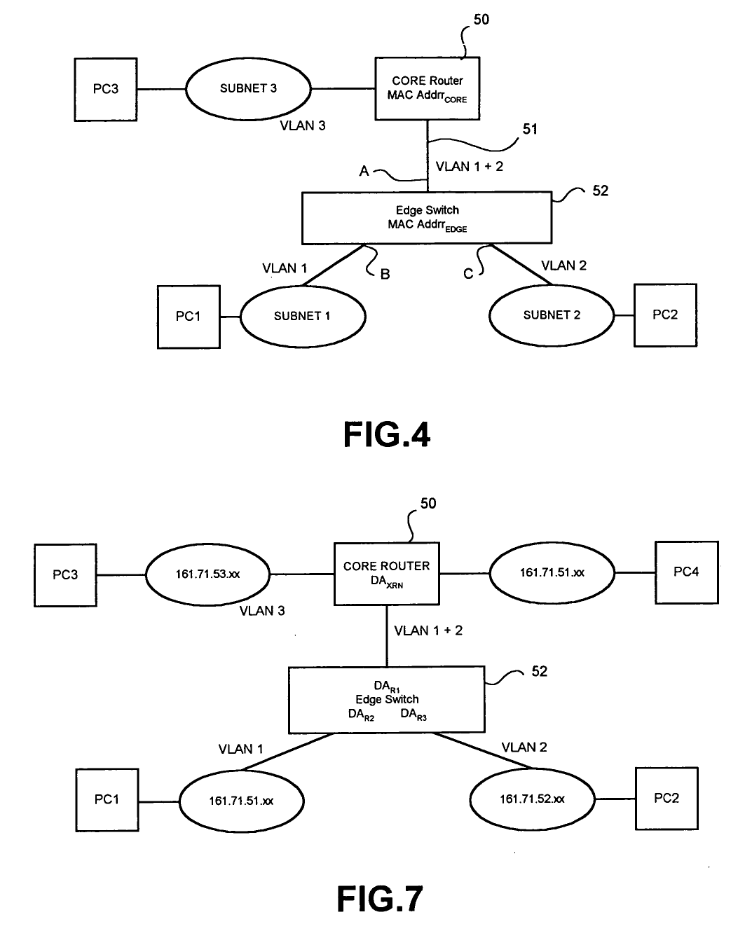

FIG. 4 illustrates part of a network organised according to the present invention and including an edge switch which is organised to act as a local router in accordance with the invention.

The network shown in FIG. 4 includes a ‘core’ router 50, which may be a router organised on the lines of the router described with reference to FIG. 2. The core router 50 is coupled by an up-link 51 to port A of an ‘edge switch’ constituted by a switch which is capable of layer 2 and layer 3 switching as described with reference to FIG. 1. Ports B and C on the edge router are coupled to a multiplicity of data terminal entities organised into a multiplicity of subnets; one of these subnets is shown as subnet 1 and includes a terminal PC1; another subnet is shown as subnet 2 and includes a terminal shown as PC2. Subnet 1 is regarded as being on ‘VLAN 1’ and subnet 2 is regarded as ‘VLAN 2’. The core router may be coupled to other networks or subnets; it is shown as connected to a subnet 3 which includes a terminal PC3.

Part of the database in the edge switch, as shown in FIG. 1, is a table of MAC addresses and corresponding destination ports. The table includes for each entry an additional bit field provided to indicate whether a received packet is to be subjected to a layer 3 look-up and switched accordingly, and this takes precedence over the destination port. The core router's MAC address is entered into this table so that all packets with this destination address will be forwarded to the layer 3 switch. This causes all packets destined for the core router to be sent to the layer 3 switch inside the edge switch.

The various terminals will send ARP packets to determine to resolve the MAC address of the core router. The terminal can use this MAC address as the destination address for the next hop for packets destined for other sub-nets.

The layer 3 switching facility within the edge switch will contain at least one and possibly two types of routing information. This information may be in a single table or split into several tables.

The first type of routing information comprises the known routes. This is a list of all known destination addresses along with the information required to route the packet. The routing table is programmed with all the entries that are local to the edge switch. This information is obtained from the core router and in the example above this would be all the network addresses on subnet 1 and subnet 2. The source address entered in the routed packet should be the same as the source address of the core router.

A second type of routing information comprises a default route which can be used if the address of the data packet does not match any of the entries in the routing table.

The embodiment to be described is implemented in hardware. The switch-thus requires a mode to use the result of the layer 2 look-up if the layer 3 look-up fails. For this purpose no default route would be programmed. If the layer 3 does not match any of the known routes, the packet is layer 2 switched to the core router 50 using the result of the layer 2 look-up. If on the other hand the invention is implemented in software, a default route table can be programmed with a default route (to router 50) that matches all packets. The source address to be inserted in the packet will be the MAC address of the edge switch and such packets will be routed to the core router.

FIG. 8 illustrates (in greatly simplified form) a routing table for the edge switch 52. The network addresses for PC1 and PC2 are associated with a port identification, usually a number but herein shown as ‘B’ and ‘C’ as well as the relevant MAC address data. If there is a default route (i.e. for a destination other than the local edge ports B and C) the packet is sent to the router 50.

It is important to note that the edge switch is not intended to provide routing for any device which is not directly reachable by way of its ‘local’ ports (e.g. B and C). It provides ‘oppoutunistic’ routing for packets which pass between devices connected to the edge switch 52 but need routing rather than bridging because they are on different sub-nets. Thus it is not intended to provide any other routing e.g. for packets which are destined for devices connected to other edge switches (not shown) connected to the router 50.

FIGS. 5 and 6 illustrate the differences between ordinary layer 2 and layer 3 switching and the switching which is employed in the present invention.

In the ordinary scheme shown in FIG. 5, a packet is received by the edge switch. A layer 2 address look-up is performed. The packet will be switched at layer 2 if an address match is found. The other possibility for the layer 2 look-up result is to forward the packet to a layer 3 look-up. Here there are two possibilities. If the layer 3 destination or the next hop is found, according to the routing tables, the packet will be routed. If the look-up fails then the packet is passed to the CPU.

FIG. 6 illustrates one implementation of the present invention, particularly suitable for a hardware version. The first stage is similar, in that the packet will be switched at layer 2 or will be forwarded to the layer 3 look-up. If the layer 3 destination is found by the layer 3 address look-up, then the packet will be routed. If however the layer 3 look-up fails (i.e. the destination is not local) the packet will be switched to the core router 50 by means of a layer 2 look-up (either using a new layer 2 look-up or storing the original).

FIG. 7 illustrates a basic network scenario. This resembles FIG. 4 except that members of VLAN 1 such as PC4 are connected to the router 50. In such an implementation, a packet originating at PC1 and destined for PC2 on VLAN 2 will arrive at the edge switch 52 and will be routed locally and not forwarded to the router 50. A packet originating at PC 1 on VLAN 1 and destined for PC3 on VLAN 3 will be switched to the router 50 and routed at that router to PC3. Packets originating at PC3 and destined for PC1 will be routed by the router 50 and then switched by the switch 52. Packets originating at or destined for PC1 and destined for or originating at PC4 as the case may be switched.

1. A method of operating a network switch which is an edge switch in an Ethernet communication network having a multiplicity of sub-nets, is arranged to receive and forward packets which include media access control address data and network address data, and is in communication with a core router, comprising:
performing a look-up in respect of a packet which is received by the edge switch from a source local to the edge switch and on a first sub-net and has a destination on a second sub-net;
forwarding the packet directly towards its destination in response to the network address data in the packet, without the packet traversing the core router, when the destination is a local destination; and
forwarding the packet from the edge switch to the core router, whenever the destination is not local to the edge switch;
said edge switch maintaining look-up tables of media access control addresses and network addresses for local sources and destinations on both the first and second sub-nets.

2. A method according to claim 1 wherein the network switch forwards the packet to the core router in response to media access control data in the packet.

3. A method according to claim 1 wherein the network switch provides a default route to the core router for network destination addresses which are not local to the network switch.

4. A network switch having ports for the reception and forwarding of Ethernet packets which include media access control address data and network address data and organised:
said edge switch is organized:
(a) to perform a media access control address look-up in respect of a first packet received by the switch;
(b) to bridge the packet if a source and a destination of the packet are on the same subnet and local to the edge switch;
(c) to perform a network destination address look-up in respect of a second packet which is received by the edge switch from a source local to the edge switch and on a first sub-net and has a destination on a second sub-net;
(d) to forward said second packet directly towards its destination in response to network address data in said second packet when the destination thereof is a local destination; and
(e) to forward said second packet from the edge switch by a default route, in response to media access control address data in said second packet, if the destination thereof is not local to the edge switch, said edge switch having look-up tables of media access control addresses and network addresses for local sources and destinations on both the first and second sub-nets.

5. A combination of a core router and an edge switch for the reception and forwarding of Ethernet packets, wherein said edge switch is organised:
(a) to perform a media access control address look-up in respect of a first packet received by the switch;
(b) to bridge said first packet when the source and a destination of the packet are on the same subnet and local to the network switch;
(c) to perform a network destination address look-up in respect of a second packet which is received by the network switch from a source local to the edge switch and on a first subnet and has a destination on a second sub-net;
(d) to forward said second packet directly towards its destination in response to network address data in said second packet when the destination thereof is a local destination; and
(e) to forward said second packet to said core router from the network switch, in response to media access control address data in said second packet, if the destination thereof is not local to the edge switch,
said network switch having look-up tables of media access control addresses and network addresses for local sources and destinations on both the first and second sub-nets.
